(19) United States
(12) Patent Application Publication
(10) Pub. No.: US 2005/0081236 A1
(43) Pub. Date: Apr. 14, 2005

(54) Data processing apparatus, data processing method, recording medium and program

(76) Inventor: Tatsuya Narahara, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 10/498,648

(22) PCT Filed: Sep. 30, 2003
(86) PCT No.: PCT/JP03/12460

(30) Foreign Application Priority Data
Oct. 16, 2002 (JP) 2002-301267

(51) Int. Cl. H04N 7/16; H04N 7/025; H04N 7/10; H04H 9/00; G06F 3/00

(52) U.S. Cl. 725/11; 725/9; 725/32; 725/46; 725/14

(57) ABSTRACT

A data processing apparatus capable of recording the user's operation histories in a small capacity, a data processing method, a recording medium and a program. A state transition detector unit 52 in a CPU 21 detects the transition of a state of contents. A metric value-setting unit in the CPU 21 sets a reference value as a metric value. A metric value conversion unit 54 in the CPU 21 converts, into a metric value, the transition of a state of contents detected by the state transition detector unit 52. A contents operation history database 61 in an HDD 26 accumulates the metric values converted by the metric value conversion unit 54 and stores them. The invention can be applied to a hard disk recorder.

### TECHNICAL FIELD

This invention relates to a data processing apparatus, a data processing method, a recording medium and a program. More specifically, the invention relates to a data processing apparatus capable of recording data in a small recording capacity without losing user's operation history and important data, a data processing method, a recording medium and a program.

### BACKGROUND ART

In recent years, there has been developed a hard disk recorder for recording television broadcast. Therefore, a user is allowed to record a program in a hard disk of a large capacity and to watch (reproduce) the recorded program on a day and at a time different from when the program was really broadcast irrespective of the real programming.

Owing to a progress in the digital technology, further, it is made possible to multiple-transmit EPGs (electronic program guides) inclusive of data related to the programs and channels simultaneously with the video and audio signals. By using the EPGs, further, there is provided service that the user can select or make a reservation of the program to enjoy watching and recording the program.

With the conventional recording/reproducing apparatus, however, the user had to select and erase the data which he considered not necessary for him at the time of managing the contents data that are recorded.

Further, tremendous number of contents can now be stored accompanying an increase in the capacity of the recording medium such as a hard disk, and the user is becoming no longer capable of grasping the tremendous number of contents that are stored.

As a result, it is becoming difficult for the user to select the contents that are not necessary for him, and the user finds it very cumbersome to carry out the operation for erasing the contents that are not necessary.

Besides, it could happen that the recorded contents in which the user is interested are buried in a tremendous number of contents that are stored, or are inadvertently erased prior to watching the contents.

Several methods have been known to solve the above problems. According to one method, in viewing a time shift of a TV program, the reproducing operation is recorded in a binary form at the speed of reproduction, the number of times of repetition of reproduction is recorded and, besides, it is judged whether the contents are read out up to the end. From these data, the degree of user's interest in the above operation is calculated, and a program preferred by the user is offered (see, for example, JP-A-2002-44542).

According to a second method, weighting of the operation is changed depending upon the content of operation in a recording/reproducing apparatus which holds the operation history of the user automatically records the programs which the user wishes to watch (see, for example, JP-A-2001-86420).

According to a third method, a program is transmitted by putting a program number (program ID) thereto at the time of broadcasting the program by using a device for collecting history data such as program rating, and the received programs that were not watched are judged and totalized (see, for example, JP-A-1999-285033).

According to the prior art, however, the data of operation event itself are directly recorded at the time of recording the operation history of the program like recorded on Jan. 1, 2001, reproduced on Jan. 10, 2001, reproduced on Jan. 11, 2001, erased on Jan. 15, 2001. Therefore, the operation history is stored in a tremendously large capacity.

### DISCLOSURE OF THE INVENTION

This invention was accomplished in view of the above circumstances and has an object of recording the operation history in a small storage capacity without losing important data.

A data processing apparatus of the invention is characterized by including:
contents ID-obtaining mechanism for obtaining IDs of the contents that are obtained;
detector for detecting the transition of the state of contents;
converter for converting the transition of the state of contents detected by the detector into a metric value; and
recording mechanism for recording the metric value converted by the converter together with the IDs of the contents.

The recording mechanism accumulates the metric values to record the operation history of the contents.

The data processing apparatus of the invention further comprises user ID-obtaining mechanism for obtaining a user ID, and the recording mechanism further records the user ID.

A data processing method of the invention is characterized by including the steps of:
obtaining IDs of the contents that are obtained;
detecting the transition of the state of contents;
converting the transition of the state of contents detected in the step of detection into a metric value; and
recording the metric value converted in the step of conversion together with the IDs of the contents.

A program in a recording medium of the invention is characterized by including the steps of:
obtaining IDs of the contents that are obtained;
detecting the transition of the state of contents;
converting the transition of the state of contents detected in the step of detection into a metric value; and
recording the metric value converted in the step of conversion together with the IDs of the contents.

A program of the invention is characterized by having a computer execute the steps of:
obtaining IDs of the contents that are obtained;
detecting the transition of the state of contents;
converting the transition of the state of contents detected in the step of detection into a metric value; and
recording the metric value converted in the step of conversion together with the IDs of the contents.

In this invention, the transition of the state of contents is converted into a metric value, and the converted metric value is recorded.

### BRIEF DESCRIPTION OF THE DRAWINGS

FIG. 1 is a block diagram illustrating the constitution of a hardware of a hard disk recorder;

FIG. 2 is a block diagram illustrating the constitution of function modules of the hardware of the hard disk recorder of FIG. 1;

FIG. 3 is a flowchart illustrating a contents management processing;

FIG. 4 is a diagram illustrating a method of setting metric values for the transition of the state corresponding to the operation;

FIG. 5 is a diagram illustrating relationships between the states of contents and the metric values;

FIG. 6 is a diagram illustrating the disposal of the contents;

FIG. 7 is a diagram illustrating a structure of operation history data;

FIG. 8 is a diagram illustrating another structure of operation history data; and

FIG. 9 is a block diagram illustrating the constitution of a personal computer.

### BEST MODE FOR CARRYING OUT THE INVENTION

An embodiment of the invention will now be described with reference to the drawings.

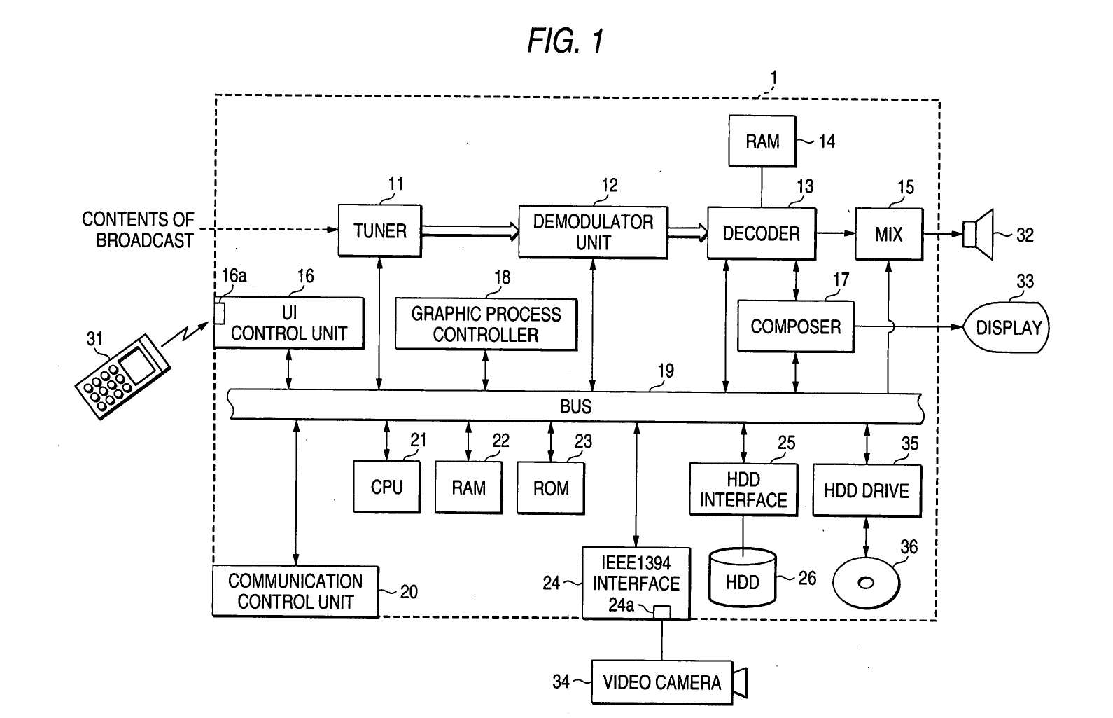

FIG. 1 is a block diagram illustrating the constitution of a hard disk recorder 1. The hard disk recorder 1 is constituted as a single unit and can be mounted an AV equipment, and can be constituted integrally with a TV receiver such as a set top box (STB).

Broadcast waves received by an antenna that is not shown are fed to a tuner 11. The broadcast waves comply with a predetermined format and may contain, for example, EPG data. The broadcast waves may be those of satellite broadcast waves, ground waves, wired waves or wireless waves.

Being controlled by a CPU 21, the tuner 11 tunes or selects broadcast waves of a predetermined channel, and sends the received data to a demodulator unit 12. The constitution of the tuner 11 may be suitably modified or expanded depending upon whether the broadcast waves that are transmitted are analog waves or digital waves. The demodulator unit 12 demodulates the received data that are digital-modulated and outputs them to a decoder 13.

In the case of, for example, a digital satellite broadcast, the digital data received by the tuner 11 and demodulated by the demodulator unit 12 are in the form of a transport stream in which have been multiplexed AV data compressed by an MPEG2 system and data to be broadcast. The AV data contain video data and audio data that constitute the body of contents to be broadcast, and the data to be broadcast contain data (e.g., EPG data) that accompanies the body of contents to be broadcast.

The decoder 13 separates the transport stream fed from the demodulator unit 12 into the AV data compressed by the MPEG2 system and the data to be broadcast (e.g., EPG data). The separated data to be broadcast are fed to an HDD 26 through a bus 19 and an HDD (hard disk drive) interface (I/F) 25, and are saved therein.

When it has been designated to directly output the received contents, the decoder 13 separates the AV data of the specified channel into the compressed video data and the compressed audio data. The separated audio data are PCM (pulse code modulation) decoded and are output to a speaker 32 through a mixer (MIX) 15. Further, the separated video data are expanded and are output to a display 33 via a composer 17.

When it has been designated to record the received contents in the HDD 26, the decoder 13 outputs the AV data of the elementary stream of a specified channel to the HDD 26 through the bus 19 and the HDD interface 25. When it has been designated to reproduce the contents stored in the HDD 26, the decoder 13 receives the AV data from the HDD 26 through the HDD interface 25 and the bus 19, separates the AV data into the compressed video data and the compressed audio data, and outputs them to the composer 17 or to the mixer 15.

A RAM (random access memory) 14 saves the work data executed by the decoder 13.

The composer 17, as required, synthesizes the video data input from the decoder 13 and the picture data input from a graphic process controller 18 together, and outputs them to a display 33. The display 33 displays (reproduces) the video signals fed from the computer 17. The speaker 32 outputs audio signals fed from the mixer 15.

A U/I (user interface) control unit 16 is a module for processing the input operation by the user. When, for example, the user operates a remote commander 31 constituted by operation buttons or switches, an operation signal (IR signal) emitted from an infrared ray emitting portion (not shown) is received by a light-receiving unit 16a and is output to the CPU 21.

The CPU 21 is a main controller for controlling the operation of the hard disk recorder 1 as a whole, and executes a variety of applications on a platform provided by an operating system (OS). The CPU 21 records or reproduces the contents by controlling the tuner 11, demodulator unit 12, decoder 13 and HDD 26 based upon the operation signals input from the remote commander 31 through, for example, the U/I control unit 16 and the bus 19.

Relying upon the broadcast data such as EPG, further, the CPU 21 forms a scheduling unit for each of the contents stored in the HDD 26, outputs it to the HDD 26 through the bus 19 and the HDD interface 25 to store it therein, and reads the scheduling unit saved in the HDD 26 and rewrites it as required.

The HDD 26 is a storage unit which is randomly accessible and is capable of storing program and data in a file form of a predetermined format, and has a large capacity of about several tens of GB (or not smaller than 100 GB). The HDD 26 is connected to the bus 19 via the HDD interface 25, receives broadcast contents and data to be broadcast such as EPG data from the decoder 13 or a communication control unit 20, records these data, and outputs the recorded data as required.

The graphic process controller 18 is a dedicated controller for forming picture data, and is equipped with a highly precise drawing function corresponding to, for example, SVGA (super video graphic array) or XGA (extended graphic array). The graphic process controller 18 forms, for example, a GUI (graphical user interface) operation screen onto which the user is allowed to input a variety of settings.

The communication control unit 20 controls the wireless communication or the wired communication using a telephone circuit or a cable. Upon effecting the communication with a server system that is not shown through the communication control unit 20, the broadcast contents or the EPG data are exchanged. The broadcast contents input to the communication control unit 20 are further input to the decoder 13 through the bus 19, and are processed in the same manner as the broadcast data input through the tuner 11 and the demodulator unit 12. Upon effecting the communication with an external unit through the communication control unit 20, further, it is allowed to receive the data related to the contents without containing EPG data, such as ground wave broadcast. The data input to the communication control unit 20 are saved in the HDD 26 through the bus 19 and the HDD interface 25.

A RAM (random access memory) 22 is a writable volatile memory used for loading an execution program of the CPU 21 and for writing the work data of the execution program. A ROM (read only memory) 23 is a read only memory for storing a self diagnosis/initialization program executed when the power source of the hard disk recorder 1 is turned on, and control codes for operating the hardware.

An IEEE (The Institute of Electrical and Electronics Engineers) 1394 interface (I/F) 24 is a serial high-speed interface capable of transmitting and receiving data of about several tens of MBps. A video camera 34 corresponding to IEEE 1394 is connected to an IEEE 1394 port 24a.

A DVD drive 35 reads the data recorded in a DVD 36 and writes the data into the DVD 36. The data of contents recorded in the HDD 26 are copied and saved in the DVD 36.

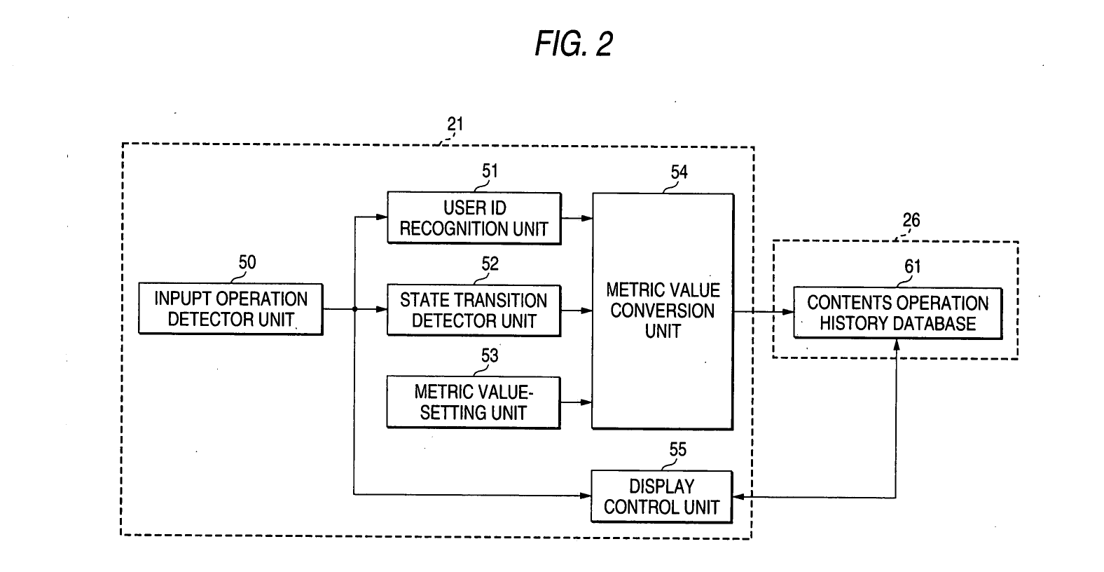

FIG. 2 is a block diagram illustrating the constitution of functional modules in the CPU 21 and in the HDD 26 in the hard disk recorder 1.

An input operation detector unit 50 in the CPU 21 detects the input operation by the user processed by the U/I control unit 16.

A user ID recognition unit 51 in the CPU 21 obtains a user ID generated from the remote commander 31 operated by the user, and makes sure who the user is depending upon the user ID that is obtained.

A state transition detector unit 52 in the CPU 21 detects the transition of state of the contents based on the input operation detected by the input operation detector unit 50.

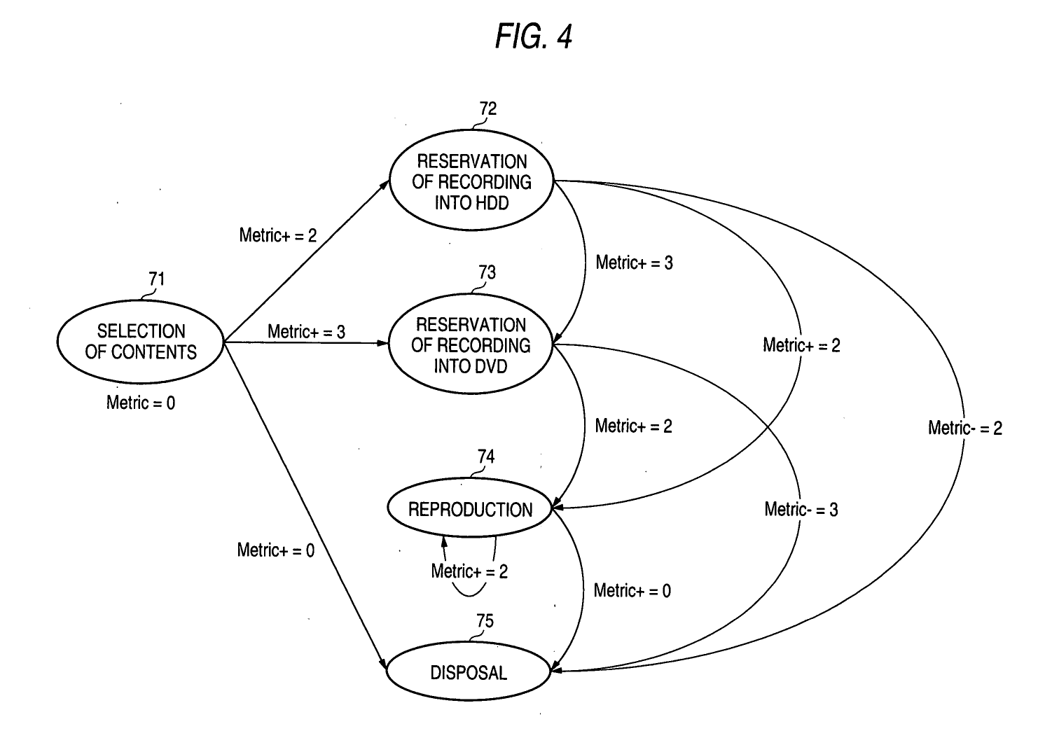

A metric value-setting unit 53 in the CPU 21 sets a reference value which is a metric value for the transition of the state of contents accompanying the operation of the remote commander 31 by the user. A method of setting a metric value by the metric value-setting unit 53 will be described later with reference to FIG. 4.

A metric value conversion unit 54 in the CPU 21 converts the transition of the state of contents detected by the state transition detector unit 52 into a metric value based upon a table of reference values of metric values corresponding to the transition of the state set by the metric value-setting unit 53.

A display control unit 55 in the CPU 21 judges, based on the input from the input operation unit 50, whether it is instructed by the user to display the metric value. When it is instructed, the display control unit reads the metric value recorded in a contents operation history database 61, and displays it on the display 33.

The contents operation history database 61 in the HDD 26 accumulates and records the metric values converted by a metric value conversion unit 54.

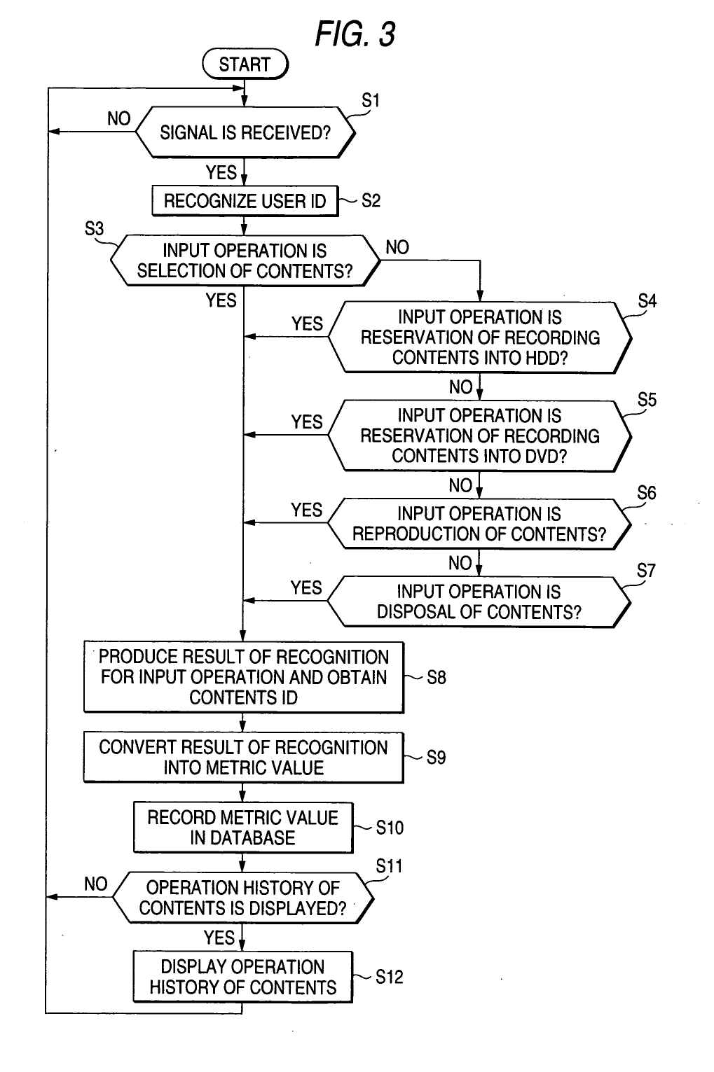

Next, described below with reference to FIG. 3 is the operation of the contents management processing.

At step S1, the input operation detector unit 50 judges whether there is an input operation by the user from the remote commander 31. If there is no input operation by the user, the input operation detector unit 50 waits until there is an input operation. If there is the input operation, the input operation detector unit 50 outputs the received signal to the user ID recognition unit 51 and to the state transition detector unit 52.

At step S2, the user ID recognition unit 51 recognizes the user ID from the received signal. That is, the remote commander 31 is allocated to the individual users. When operated, the remote commander 31 puts its own (user's) ID and outputs a signal corresponding to the operation, enabling the ID to be recognized. If the history is not required for the individual user (e.g., if the history needs be the one for a unit of family),the user ID recognition processing may be omitted.

At step S3, the state transition detector unit 52 judges whether the input operation by the user is for selecting the contents. If the input operation by the user is for selecting the contents, the processing proceeds to step S8. If the input operation by the user is not for selecting the contents, the processing proceeds to step S4.

At step S4, the state transition detector unit 52 judges whether the input operation by the user is for making a reservation for recording the contents in the HDD 26. If the input operation by the user is for making a reservation for recording the contents in the HDD 26, the processing proceeds to step S8. If the input operation by the user is not for making a reservation for recording the contents in the HDD 26, the processing proceeds to step S5.

At step S5, the state transition detector unit 52 judges whether the input operation by the user is for making a reservation for recording the contents in the DVD 36. If the input operation by the user is for making a reservation for recording the contents in the DVD 36, the processing proceeds to step S8. If the input operation by the user is not for making a reservation for recording the contents in the DVD 36, the processing proceeds to step S6.

At step S6, the state transition detector unit 52 judges whether the input operation by the user is for reproducing the contents. If the input operation by the user is for reproducing the contents, the processing proceeds to step S8. If the input operation by the user is not for reproducing the contents, the processing proceeds to step S7.

At step S7, the state transition detector unit 52 judges whether the input operation by the user is for disposing of the contents. If the input operation by the user is for disposing of the contents, the processing proceeds to step S8.

At step S8, the state transition detector unit 52 outputs, to the metric value conversion unit 54, the results of recognition of the input operations recognized in the processings of steps S3 to S7, and obtains the ID of contents now being processed from the EPG data. The EPG data are obtained in advance by the communication control unit 20 from the server system, and are recorded in the HDD 26.

At step S9, the metric value conversion unit 54 converts the result of recognition at the state transition detector unit 52 into a metric value based on a reference value that has been set in advance by the metric value-setting unit 53. The details thereof will be described later with reference to FIG. 4. When the metric value has been operated already for the same contents, the metric value conversion unit 54 accumulates the metric values and outputs them to the contents operation history database 61.

At step S10, the contents operation history database 61 records the metric values converted by the metric value conversion unit 54. That is, the operation history of contents by the user is recorded as a cumulative value of metric values.

At step S11, the display control unit 55 judges, based on the instruction from the user, whether the operation history of contents be displayed. When the operation history of contents is to be displayed, the processing proceeds to step S12. When the operation history of contents is not to be displayed, the processing returns back to step S1.

At step S12, the display control unit 55 reads the operation history of contents from the contents operation history database 61, and displays it on the display 33. The processing, then, returns back to step S1 to repeat the subsequent processings.

Described below next with reference to FIG. 4 is a method of setting a reference metric value by the metric value-setting unit 53. Prior to executing the processing illustrated in FIG. 3, the user sets, in advance, a reference value described below. The reference value can be changed, as required, by the user.

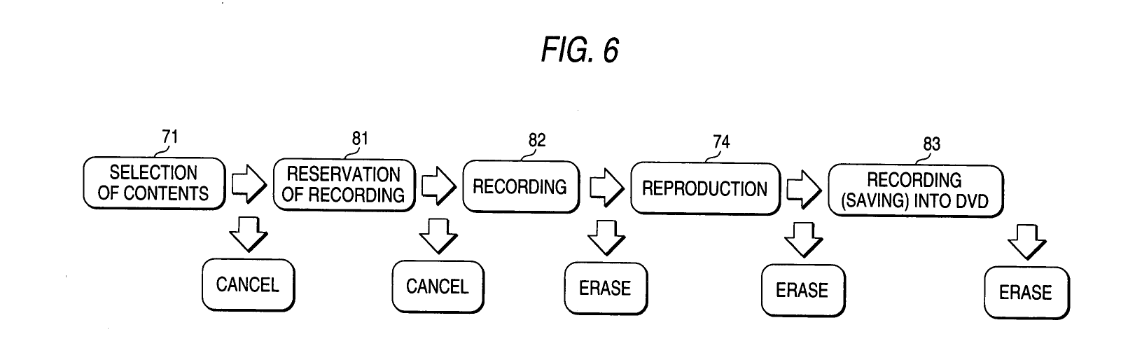

When the input operation is the “selection of contents” 71, the reference metric value is set to be, for example, “0”. The contents can be transited from this state into three states. The three states of contents include “reservation of recording into HDD” 72, “reservation of recording into DVD” 73 and “disposal” 75. Here, the “reservation of recording into HDD” 72 stands for a transition state of making a reservation for recording into the HDD 26 and, then, the data are really recorded into the HDD 26. The “reservation of recording into DVD” 73 stands for a transition state of making a reservation for recording into the DVD 36 and, then, the data are really recorded into the DVD 36. The meaning of the “disposal” 75 will be described later with reference to FIG. 6.

A reference metric value corresponding to the transition from the state of “selection of contents” 71 into the “reservation of recording into HDD” 72 is, for example, “2”. Reference metric values corresponding to the transition from the state of “selection of contents” 71 into the “reservation of recording into DVD” 73 and to the transition from the state of “selection of contents” 71 into the “disposal” 75 are, for example, “3” and “0”, respectively.

It is now presumed that the state of contents is transited from the “selection of contents” 71 into the “reservation of recording into HDD” 72. The contents can be transited from this state into three states. The three states of contents include “reservation of recording into DVD” 73, “reproduction” 74 and “disposal” 75.

A reference metric value corresponding to the transition from the state of “reservation of recording into HDD” 72 into the “reservation of recording into DVD” 73 is, for example, “3”. Reference metric values corresponding to the transition from the state of “reservation of recording into HDD” 72 into the “reproduction” 74 and to the transition from the state of “reservation of recording into HDD” 72 into the “disposal” 75 are, for example, “2” and “−2”, respectively.

It is further presumed that the state of contents is transited from the state of “selection of contents” 71 into the “reservation of recording into DVD” 73. The contents can be transited from this state into two states. The two states of contents include the “reproduction” 74 and the “disposal” 75.

A reference metric value corresponding to the transition from the state of “reservation of recording into DVD” 73 into the “reproduction” 74 is, for example, “2”. A reference metric value corresponding to the transition from the state of “reservation of recording into DVD” 73 into the “disposal” 75 is, for example, “−3”.

It is presumed that the state of contents is transited from the state of “reservation of recording into HDD” 72 or “reservation of recording into DVD” 73 into the “reproduction” 74. The contents can be transited from this state into two states. The two states of contents include the “reproduction” 74 and the “disposal” 75.

A reference metric value corresponding to the transition from the state of “reproduction” 74 into the “reproduction” 74 is, for example, “2”. A reference metric value corresponding to the transition from the state of “reproduction” 74 into the “disposal” 75 is, for example, “0”.

As described above, the metric value-setting unit 53 sets a reference metric value of a given integer for the state of the contents and for the user's input operation for the transition.

At step S9 in FIG. 3 as described above, the metric value conversion unit 54 reads, from the metric value-setting unit 53, a reference value corresponding to the transition of the state detected by the state transition detector unit 52, and outputs it. When, for example, a reservation is made to record the selected contents into the HDD 26, a metric value “2” is output. When a reservation is made to record the contents recorded in the HDD 26 into the DVD 36, a metric value “3” is output.

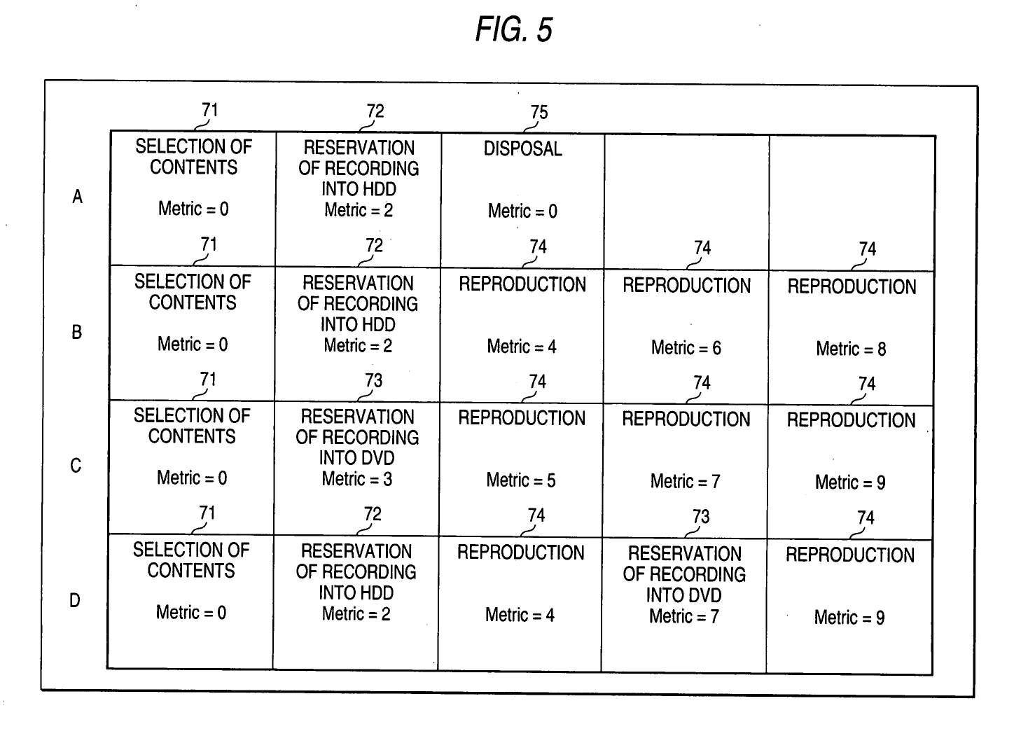

FIG. 5 illustrates exemplarily changes in the metric values that change accompanying a change in the state of the contents. In this example, reference values are so set that when reservation is made to finally record the contents in the HDD 26, the cumulative metric value becomes an even number and when the reservation is made to record in the DVD 36, the cumulative metric value becomes an odd number.

When a reservation has been made to finally record the contents in the HDD 26, there are two transition patterns, i.e., row A and row B in FIG. 5. A feature resides in that a metric value accumulated depending upon the transition finally becomes an even number. In the case of the row. A, the contents are transited to three states, i.e., from the “selection of contents” 71 to “reservation of recording into HDD 26” 72 to “disposal” 75. At this moment, the cumulative metric values corresponding to the transitions of the state of contents vary into “0”, “2” and “0”.

Similarly, in the case of the row B, the contents are transited to five states, i.e., from the “selection of contents” 71 to “reservation of recording into HDD” 72 to “reproduction” 74 to “reproduction” 74 to “reproduction” 74. At this moment, the cumulative metric values corresponding to the transitions of the state of contents vary into “0”, “2”, “4”, “6” and “8”.

Next, when a reservation has been made to finally record the contents in the DVD 36, there are two transition patterns, i.e., row C and row D in FIG. 5. A feature resides in that a metric value accumulated depending upon the transition finally becomes an odd number. In the case of the row C, the contents are transited to five states, i.e., from the “selection of contents” 71 to “reservation of recording into DVD” 73 to “reproduction” 74 to “reproduction” 74 to “reproduction” 74. At this moment, the accumulated metric values corresponding to the transitions of the state of contents vary into “0”“3”, “5”, “7” and 9”.

Similarly, in the case of the row D, the contents are transited to five states, i.e., from the “selection of contents” 71 to “reservation of recording into HDD” 72 to “reproduction” 74 to “reservation of recording into DVD” 73 to “reproduction” 74. At this moment, the cumulative metric values corresponding to the transitions of the state of contents vary into “0”, “2”, “4”, “7” and “9”.

Thus, depending upon the cumulative metric value that assumes an even number (contents are recorded in the HDD 26) or an odd number (contents are recorded in the DVD 36), the position where the contents are recorded can be judged from the metric value.

Described below with reference to FIG. 6 is the “disposal” 75 which is one of the states of contents in FIG. 4. In FIG. 4, there are five routes of transition to the “disposal” 75 which is a state of contents.

A first route is when the “selection of contents” 71 is cancelled while the state of contents is the “selection of contents” 71. A second route is when the “reservation of recording” 81 is cancelled while the state of contents is transited from the “selection of contents” 71 to the “reservation of recording” 81. Here, the “reservation of recording” 81 stands for a reservation of recording, i.e., “reservation of recording into HDD” 72 or “reservation of recording into DVD” 73 in FIG. 4, and there are two states of contents.

A third route is when the “recording” 82 is erased while the state of contents is transited from the “reservation of recording” 81 to the “recording” 82. Here, the “recording” 82 stands for a state of being recorded after the reservation of recording, i.e., after the “reservation of recording into HDD” 72 or the “reservation of recording into DVD” 73 in FIG. 4, and there are two states of contents. A fourth route is when the “reproduction” 74 is erased while the state of contents is transited from the “recording” 82 to the “reproduction” 74. A fifth route is when the “recording (saving) into DVD” 83 is erased while the state of contents is transited from the “reproduction” 74 to the “recording (saving) into DVD” 83. Here, the “recording (saving) into DVD” 83 stands for a state of recording and saving the contents in the DVD 36 after “reservation of recording into DVD” 73 in FIG. 4.

As described above, the above five states of contents are all the state of contents, i.e., “disposal” 75 in FIG. 4. However, the reference metric value for the transition of the state of contents differs depending upon the kind of input operation by the user. For example, cancellation of the “reservation of recording” 81 is to cancel the state of reservation of recording, i.e., is to cancel the “reservation of recording into HDD” 72 or to cancel the “reservation of recording into DVD” 73. Therefore, a reference metric value for the transition becomes “−2” or “−3”, and the cumulative metric value is subtracted.

Cancellation of the “recording” 82 is to cancel the state of recording after the reservation of recording, i.e., after the “reservation of recording into HDD” 72 or after the “reservation of recording into DVD” 73. Therefore, a reference metric value for the transition becomes “−2” or “−3”, and the cumulative metric value is subtracted.

Further, when the “recording (saving) into DVD” 83 is cancelled, the recording state is cancelled after the reservation of recording which is “reservation of recording into DVD” 73. Therefore, a reference metric value for the transition becomes “−3” and the cumulative metric value is subtracted. The metric value for the transition to “DISPOSAL” 75 other than the above becomes 0.

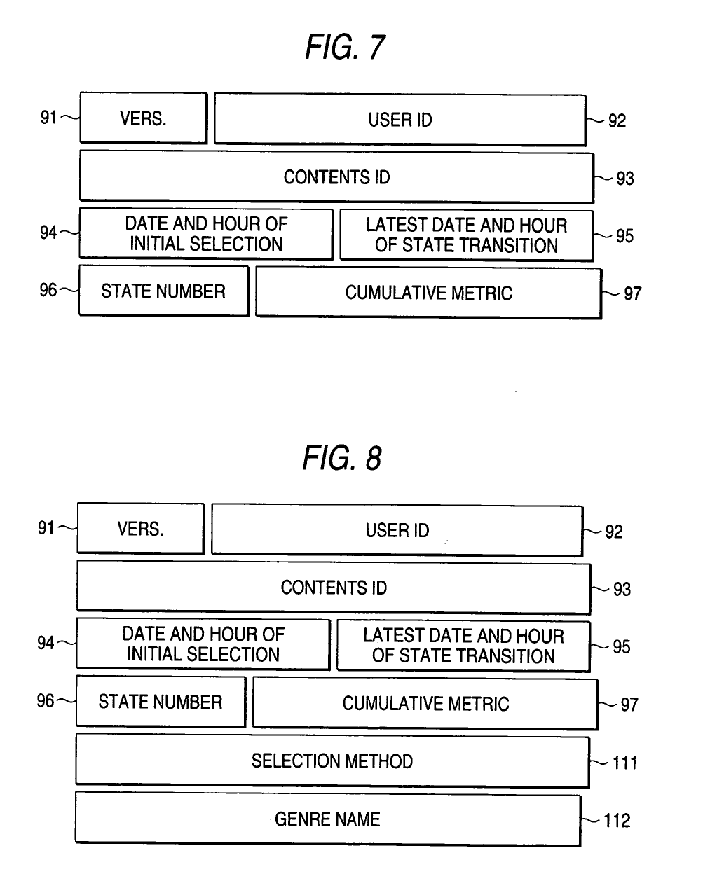

FIG. 7 illustrates an example of a structure of operation history data recorded in the contents operation history database 61 by the metric value conversion unit 54.

The “Vers.” 91 represents the selection of a number of times operated by the user concerning the contents, which is detected by the state transition detector unit 52. The “user ID” 92 is an ID number for identifying the user and is recognized by the user ID recognition unit 51. The “contents ID” 93 is detected by the state transition detector unit 52.

The “date and hour of initial selection” 94 represents the date and hour of when the user has selected the contents for the first time, and is detected by the state transition detector unit 52. The “latest date and hour of state transition” 95 represents the latest date and hour of when the state of contents is transited, and is detected by the state transition detector unit 52. The “state number” 96 represents the state number (e.g., “recording into HDD” 72 in FIG. 4) of the state of contents, and is detected by the state transition detector unit 52. The “cumulative metric value” 97 represents the accumulated metric value due to the transition of the state of contents, and is operated by the metric value conversion unit 54.

FIG. 8 illustrates another example of structure of the operation history data. In this case, the “selection method” 111 and the “genre name” 112 are added to the structure of operation history data of FIG. 7. This is for adding, as data, the depth of relationship to particular operations of the user. For this purpose, the metric value-setting unit 53 sets the depths of relation between the operation and the user as metric values, and records them as numerical values.

The “selection method” 111 describes a method of selecting the contents, such as retrieval, contents table of EPG, contents navigation and comments for recommending the contents. The “genre name” 112 describes the name of genre of when the contents are retrieved.

As described above, the depth of relationship to particular operations by the user can be added as detailed data to the structure of operation history data.

The structure of operation history data are suitably read out and are analyzed by an application for analyzing the liking of the user. Based on the results of analysis, the contents that meet the liking of the user are, then, automatically recorded.

In the foregoing, the contents were obtained by the tuner 11. The invention can be applied even when the contents delivered through the internet or any other network are to be obtained. Further, the invention was described when it was applied to the hard disk recorder. The invention, however, can also be applied even when it is applied to the data processing apparatus other than the hard disk recorder.

The above series of processings can be executed relying upon the hardware or the software. When a series of processings are executed by the software, a program constituting the software can be installed from a program storage medium into a computer incorporated in a dedicated hardware or into a general-purpose personal computer that is capable of executing a variety of functions upon installing various kinds of programs.

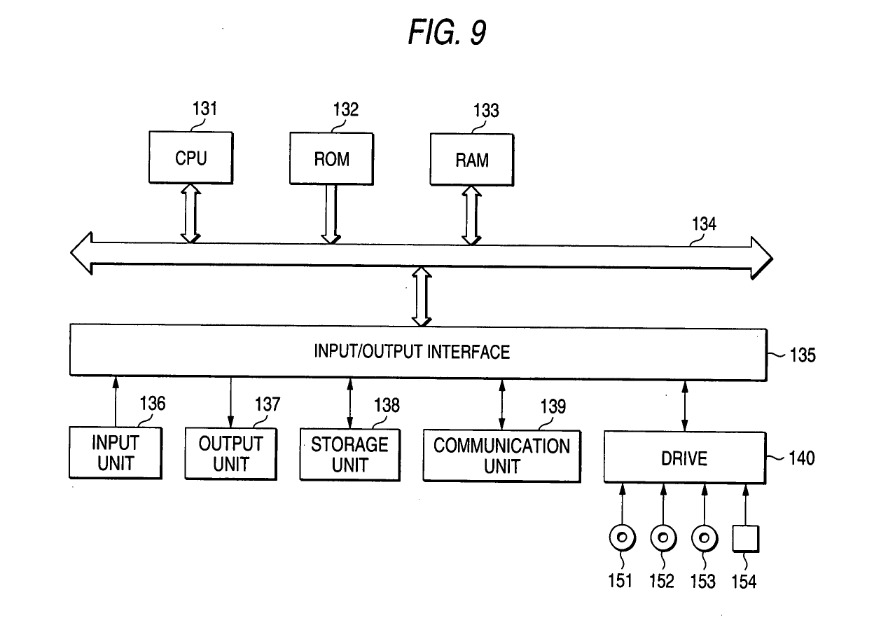

FIG. 9 is a diagram illustrating exemplarily the constitution of a personal computer for executing the above processings. In FIG. 9, a CPU 131 executes a variety of processings according to a program stored in a ROM 132 or according to a program loaded into a RAM 133 from a storage unit 138. The RAM 133 further stores the data necessary for the CPU 131 to execute a variety of processings.

The CPU 131, ROM 132 and RAM 133 are connected to each other through a bus 134. To the bus 134 is further connected an input/output interface 135.

To the input/output interface 135, there are connected an input unit 136 comprising a keyboard and a mouse, a display comprising a CRT and an LCD, an output unit 137 comprising a speaker, the storage unit 138 constituted by a hard disk, and a communication unit 139 constituted by a modem and a terminal adapter. The communication unit 139 executes a communication processing through a network inclusive of an internet (not shown), and a communication processing with a corresponding broadcast receiving/recording device (not shown).

As required, further, a drive 140 is connected to the input/output interface 135. There are further suitably mounted a magnetic disk 151, an optical disk 152, a magnet-optic disk 153 and a semiconductor memory 154, and computer programs read out therefrom are, as required, installed in the storage unit 138.

Referring to FIG. 9, a program storage medium for storing a program that is installed in a computer and can be executed by the computer, is constituted by the magnetic disk 151 (inclusive of a floppy disk), the optical disk 152 (inclusive of CD-ROM (compact disk-read only memory), DVD (digital versatile disk)), the magnet-optic disk 153 (inclusive of MD (mini-disk)), a package medium constituted by the semiconductor memory 154, the ROM 132 which temporarily or permanently stores the program, or a hard disk which constitutes the storage unit 138. The program is stored in the program storage medium, as required, via an interface such as router or modem by utilizing a wired or wireless communication medium, such as local area network, internet or digital satellite broadcast.

In this specification, the steps for describing a program stored in the program storage medium include not only the processings that are executed in time series along the described order but also the processings which are not necessarily executed in time series but are executed in parallel or individually.

### Industrial Applicability

As described above, the invention accumulate the histories of operation. In particular, the invention decreases the capacity. The invention, further, decreases the scale of the apparatus and suppresses an increase in the cost.

1. A data processing apparatus characterized by comprising:
contents ID-obtaining mechanism for obtaining IDs of the contents that are obtained;
detector for detecting the transition of the state of contents;
converter for converting the transition of the state of contents detected by the detector into a metric value; and
recording mechanism for recording the metric value converted by the converter together with the IDs of the contents.

2. A data processing apparatus according to claim 1, characterized in that the recording mechanism accumulates the metric values to record the operation history of the contents.

3. A data processing apparatus according to claim 1, characterized by further comprising user ID-obtaining mechanism for obtaining a user ID, wherein the recording mechanism further records the user ID.

4. A data processing method for a data processing apparatus that reproduces the recorded contents, characterized by including the steps of:
obtaining IDs of the contents that are obtained;
detecting the transition of the state of contents;
converting the transition of the state of contents detected in the step of detection into a metric value; and
recording the metric value converted in the step of conversion together with the IDs of the contents.

5. A recording medium recording a computer-readable program for reproducing the recorded contents, the program characterized by including the steps of:
obtaining IDs of the contents that are obtained;
detecting the transition of the state of contents;
converting the transition of the state of contents detected in the step of detection into a metric value; and
recording the metric value converted in the step of conversion together with the IDs of the contents.

6. A program for reproducing the recorded contents, characterized by executing the steps of:
obtaining IDs of the contents that are obtained;
detecting the transition of the state of contents;
converting the transition of the state of contents detected in the step of detection into a metric value; and
recording the metric value converted in the step of conversion together with the IDs of the contents.
